(19) United States
(12) Patent Application Publication
(10) Pub. No.: US 2025/0021813 A1
(43) Pub. Date: Jan. 16, 2025

(54) APPARATUS AND METHOD FOR COLLABORATIVE NEURAL ARCHITECTURE SEARCH

(71) Applicant: CHUN YAN ENOCH SIT, HONG KONG (CN)

(72) Inventor: CHUN YAN ENOCH SIT, HONG KONG (CN)

(21) Appl. No.: 18/352,284

(22) Filed: Jul. 14, 2023

(51) Int. Cl. G06N 3/08

(52) U.S. Cl. CPC G06N 3/08

(57) ABSTRACT

This application embodiment relates to the field of neural architecture search technology, particularly to an apparatus and method for collaborative neural network search. The apparatus includes a first node for providing a preset search space and dataset, a second node for generating a variational autoencoder and partitioning the search space; at least two cooperating third nodes, the third node is used to determine the performance of multiple candidate neural architectures, train a performance predictor, and update the embedding position based on the gradient direction provided by the performance trainer, wherein data information is shared between different third nodes. By using the variational autoencoder, the third node can hypothesize that similar unit structures/neural architectures have similar performance on the same dataset when conducting the search, collaboratively searching for the best neural architecture (by broadcasting the evaluation results of its neural architecture) and achieving effective evaluation of different neural architectures.

### TECHNICAL FIELD

This application relates to the field of neural architecture search, in particular relates to an apparatus and method for collaborative neural architecture search.

### BACKGROUND

Neural Architecture Search (NAS) is a technique that specifically studies how to automatically design high-performance deep neural network architectures without the need for manual tuning, enabling the design of high-performance deep neural network architectures without requiring users to have extensive expert experience. NAS is an optimization problem that uses appropriate optimization algorithms to automatically obtain the best structure for a neural network.

Currently, most of the results output by neural architecture search are composed of small, repeated mathematical models stacked together. Current research mostly focuses on finding the optimal structure of smaller repeating units, called “cells,” that repeat themselves in the overall structure.

However, existing neural architecture search techniques require evaluating the adaptability of different neural architectures to a particular dataset. This critical operation step is very time-consuming and computationally intensive, limiting the application and development of neural architecture search.

### SUMMARY

This application aims to provide a method and apparatus for collaborative neural network search that can solve at least some of the defects of existing neural architecture search.

In a first aspect, the apparatus includes: a first node for providing a preset search space and dataset; a second node for generating a variational autoencoder and dividing the search space; wherein the variational autoencoder is used to embedding a neural architecture to a vector space so that neural architectures with similar structures have adjacent embedding positions; at least two mutually collaborative third nodes; wherein the third node is used to determine a performance of multiple candidate neural architectures, train a performance predictor, and update the embedding position based on the gradient direction provided by the performance trainer; wherein data information is shared among different third nodes, and the data information comprises the performance of candidate neural architectures.

Alternatively, the variational autoencoder is trained on an encoder training dataset and broadcasted to the third nodes; wherein the encoder training dataset consists of several randomly generated neural architectures that meet the search space; and the distribution of the neural architectures in the vector space is selected from a Gaussian distribution with a standard deviation of 1 or the distribution specified by the first node.

Alternatively, the step of updating the embedding position based on the gradient direction provided by the performance trainer includes: determining the initial embedding position; calculating the gradient direction given by the performance predictor through backpropagation algorithm, and obtaining the updated result of the initial embedding position through gradient ascent; wherein the updated result is an optimized embedding position that performs better than the initial embedding position.

Alternatively, the initial embedding position is the embedding position of the initial neural architecture in the vector space, which is selected from the neural architecture assigned by the first node or a randomly generated neural architecture; wherein the randomly generated neural architecture is generated randomly based on the identifier as the random seed and the setting of the search space; and the identifier is assigned by the second node or generated automatically by the third node.

Alternatively, the initial embedding position is the embedding position according to the top N preferred neural architectures in the vector space; wherein N is a positive integer, and the preferred neural architectures are sorted according to the performance evaluation results, and neural architectures with better performance have lower numbers.

Alternatively, to evaluate different neural architectures simultaneously across different process or work sub node, the search process uses a set of Auto-encoder (and auto-decoder) register in a distributed ledger and a public key infrastructure to divide the neural architecture search space to perform neural architecture search during the search space division process where the public keys are used in determine the vector to be feed into the Auto-encoder, which in turn, generate the next neural architecture to be trained.

Alternatively, the public key itself represent a point in the neural architecture search space. This allows minimal communication in a peer to peer (or distributed) network. Once a node generated a public-key and private key, the node can start the model evaluation process with the distributed ledger retrieved from its peer.

Alternatively, the node id can be calculated via (P mod N) where P is the integer representation of the public key and N is the Maximum number of nodes in a distributed network. The search process starts the initialization process within a swam of search nodes through broadcasting Auto-encoders that encodes the structure of neural architectures.

Alternatively, To write valid Auto-encoders in the blockchain requires heavy computation. This search process uses a probabilistic verification approach to verify the proof of work involved in training auto-encoders. (where FIG. 2 and FIG. 3 reveals one of the kind of probabilistic method)

Alternatively, the auto-encoder stored in a distributed ledger allows the search space divide evenly across each node. Search node then uses the (verified) results from other peers and the (verified) auto-encoder (and its ID generate from its public key as the input of the auto-encoder) to in the distributed ledger to find the next neural architecture to search.

Alternatively, the step of training to obtain a performance predictor comprises: obtaining k sets of training data to form a predictor training dataset; training the performance predictor based on the predictor training dataset; wherein each set of training data comprises: candidate neural architecture and its corresponding performance, and the candidate neural architecture is sampled from a peripheral area of the initial embedding position.

Alternatively, the third node comprises: a search sub-node for determining candidate neural architectures; a work sub-node for determining the performance of the candidate neural architectures, training a performance predictor, and updating the embedding position; and a validation sub-node for performing a verification process based on a Merkel tree in a non-trusted environment to verify the data information broadcasted by other third nodes.

Alternatively, the work sub-node is further configured to test the performance of the candidate neural architectures through the dataset or obtain the performance of the candidate neural architectures by collecting data information from other third nodes.

In a second aspect, the method includes follow steps: S1: determining and training an initial neural architecture; S2: mapping the initial neural architecture to an initial embedding position in a vector space using a variational autoencoder; S3: broadcasting the data information of the initial neural architecture; S4: obtaining k sets of training data to form a predictor training dataset, wherein k is a positive integer; S5: training a performance predictor using the predictor training dataset; S6: updating the embedding positions in the direction of the gradient provided by the performance predictor using gradient ascent, such that the updated embedding positions perform better than the initial embedding position; S7: repeating steps S1 to S6 L times, wherein L is a positive integer.

Alternatively, the method further includes: S8: jumping to the embedding position of the top N preferred neural architectures in the vector space; wherein N is a positive integer, and the preferred neural architectures are sorted by performance, and those with better performance have a lower index.

One advantage of the present application is that candidate neural architectures are embedding to a continuous encoding vector space through an appropriate variational autoencoder, that enables the third node to make assumptions about the similarity in performance of similar unit structures/neural architectures on the same dataset during search, and collaboratively search for the best neural architecture (by broadcasting the evaluation results of their neural architectures) to effectively evaluate different neural architectures.

Another advantage of the present application is that it can be transformed into any blockchain-related application, thereby encouraging people to invest their computing resources to obtain tokens. In this way, the search for neural architectures can continue as long as there are people willing to invest computing resources in exchange

### BRIEF DESCRIPTION OF DRAWINGS

One or more embodiments are exemplarily illustrated by the pictures in the corresponding drawings, and these exemplary illustrations do not constitute a limitation on the embodiments. Elements in the drawings with the same reference numerals represent similar elements, unless otherwise stated. The drawings do not impose any proportional limitations, unless otherwise stated.

FIG. 1 is a schematic diagram of the apparatus for collaborative neural architecture search according to an embodiment of the present application;

FIG. 2 is a schematic diagram of a verification process according to an embodiment of the present application;

FIG. 3 is a schematic diagram of a Merkle tree; Parameter tunning process is a process that responsible for training neural architecture proposed by the search process. During the training process, weights can be shared among neural architectures instead of train it from scratch. A hash is computed from the public key, the hash of the training data set, the current model state (including the parameters) and the gradient each epoch. After the parameter tunning processes, all the hashes generated previously are used to construct a Merkle tree.

FIG. 4 is a flowchart of a method for collaborative neural architecture search according to an embodiment of the present application.

### DETAILED DESCRIPTION

To facilitate understanding of the present invention, a more detailed description of the invention is provided below in conjunction with the accompanying drawings and specific embodiments. It should be noted that when a component is described as “fixed to” another component, it can be directly on the other component or there may be one or more intermediate components between them. When a component is described as “connected to” another component, it can be directly connected to the other component or there may be one or more intermediate components between them.

The terms “top”, “bottom”, “inner”, “outer”, “bottom”, etc. used in this specification to indicate orientation or positional relationships are based on the orientation or positional relationships shown in the drawings, and are only used for ease of describing and simplifying the description of the invention, and not to indicate or imply that the device or component referred to must have a specific orientation or be constructed and operated in a specific orientation.

Therefore, they cannot be understood as limiting the present invention. In addition, the terms “first”, “second”, “third”, etc. are only used for descriptive purposes and cannot be understood as indicating or implying relative importance.

Unless otherwise defined, all technical and scientific terms used in this specification have the same meaning as understood by those skilled in the art of the present invention. The terms used in this specification to describe specific embodiments of the invention are intended to be for illustrative purposes and not for limiting the invention. The term “and/or” used in this specification includes any and all combinations of one or more of the listed items.

Furthermore, the technical features involved in the different embodiments of the present invention described below can be combined with each other as long as they do not conflict with each other.

Neural Architecture Optimization (NAO) is a research methodology that utilizes gradient-based methods to optimize neural network architectures in a more compact vector space.

Specifically, it first trains an encoder and decoder with a set of randomly generated architectures, and encodes the set of architectures into a set of vectors. Each architecture is evaluated for performance using a given dataset.

Then, the architectures and their corresponding performance evaluation results are used to train a set of vectors and predictors. New sets of vectors are generated through gradient ascent on the gradients of the inputs with respect to the predictor output of the previous set of vectors.

Finally, a new set of architectures can be decoded from these vectors using the decoder trained in the first step. The entire process can be repeated an arbitrary number of times to obtain better results.

However, during the implementation of this application, the applicant finds that: the operation steps of evaluating different neural architectures for a given dataset are time-consuming and require a lot of computational resources. Moreover, to evaluate different neural architectures simultaneously, an additional central coordination module is required for resource allocation.

Furthermore, there are other technical issues such as how to properly partition the search space to reduce communication between different evaluation processes (i.e., reduce the messages involved in weight sharing), how to provide guidance for neural architecture search to find better neural architectures, and how to determine when the neural architecture search should stop.

The method and apparatus for collaborative neural architecture search and s according to this embodiment of the application can effectively solve one or more of the above problems by training and validating neural architectures in a distributed or discrete manner, enabling effective evaluation of different neural architectures and facilitating widespread use.

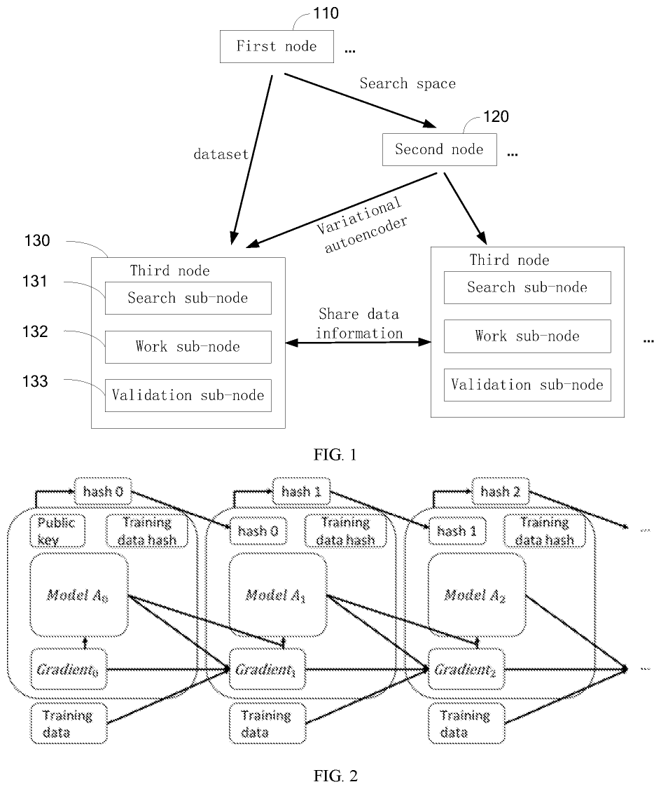

FIG. 1 is a schematic diagram of the apparatus for collaborative neural architecture search according to the present embodiment. Concretely, the system for searching a mathematical model having weights/parameters which best describes a dataset. As shown in FIG. 1, according to the functions performed, the system device can roughly include three different nodes. In this article, for the sake of simplicity, they can be referred to as “first node 110”, “second node 120”, and “third node 130”, respectively. Each of the nodes run the process including: an Initialization process, search space division process, parameter tunning process, validation process and search process.

A “node” refers to a computing entity or functional module used to perform a specific process and implement the corresponding function, which is shown in a rectangular box in FIG. 1 as an example, without limiting its specific implementation. It is similar to the technical term “node” in blockchain technology. For example, the “full node” described in Bitcoin technology.

The first node 110 is used to provide a preset search space and dataset. In other words, the first node 110 provides the search space and dataset for neural architecture search, and distributes the settings of the dataset and search space to other nodes.

The “search space” specifies the types of neural architecture that can be searched or allowed to be generated, as well as the method for evaluating the performance of neural architecture (such as how to determine and test the accuracy of neural architecture). The dataset contains testing and training data. In some embodiments, the dataset may also include validation data as needed.

The second node 120 is used to generate a variational autoencoder and partition the search space so that neural architectures can be combined together based on structural similarity. The generated variational autoencoder can be broadcasted to other nodes for encoding and decoding of neural architectures. In this article, “encoding” refers to mapping neural architecture as input to a continuous encoded vector space through the variational autoencoder. “Decoding” refers to remapping the specific position in the vector space to a discontinuous neural architecture through the variational autoencoder.

Specifically, in the process of generating the variational autoencoder, the second node can first randomly generate several neural architectures based on the search space given by the first node. Then, use these randomly generated neural architectures as training data for the encoder, and train a variational autoencoder that can be used. In addition, the trained variational autoencoder can be broadcasted to other nodes for validation. Validation process is a process to validate whether a set of parameters is tuned for at least E epochs given the initial state of the model. The Merkle tree, each instance of the models and the gradients generated amid of the training processes are used in validation process. Validation process involved the following steps: Firstly, a validation node will verify the first and last pair hashes first. Then, it randomly samples a pair of hashes generated during the training process. With this validation procedure, the validation does not need to retrain the neural network. Instead the validation node validates the training process validates the training process with a correct probability of 1-1/((E/2-2)) where E is the total number of epochs to train the neural network with the assumption that the adversary tries to spam the network without devote computation power to training.

In this embodiment, the distribution of the encoding results of the variational autoencoder in the vector space can be a Gaussian distribution with a standard deviation of 1, so that the encoding results of similar neural architectures can be combined. Alternatively, when a similarity measure is specified at the first node, the distribution specified by the first node, such as a binomial distribution, can also be used.

The third node 130 is set up with at least two nodes, each of which is responsible for searching a part of the search space. Different third nodes 130 cooperate with each other and can share data information to help reduce the consumption of computing resources and time. In some embodiments, this data information includes the performance of neural architectures. Alternatively, this data information may include training results for neural architectures.

Specifically, please refer to FIG. 1, the third node 130 includes at least one search sub-node 131 and one work sub-node 132. The search sub-node 131 can select candidate neural architectures, while the work sub-node 132 can respond to requests from the search sub-node 131 by training the candidate neural architectures and evaluating their performance.

The work sub-node 132 can train the candidate neural architectures using training data to obtain corresponding neural models and determine the performance of the neural models (e.g., accuracy) using test data. Alternatively, the work sub-node 132 can obtain training results and/or performance of the candidate neural architectures by collecting data information from other third nodes. Similarly, the training results of the work sub-node 132 can be obtained through self-training using a training dataset, or by collecting data information from other third nodes.

In practical use, the third node 130 performs an optimization process of continuously updating the embedding position. It can update the embedding position based on the gradient direction provided by the performance trainer to obtain neural architectures with better performance.

Specifically, gradient ascent can be used to update the embedding positions. In this paper, “gradient ascent” refers to the process of gradually finding the embedding position with the maximum gradient direction. The gradient ascent method can be any suitable type according to the actual needs, not limited to step-by-step ascent, as long as it can find the embedding position that maximizes performance. Alternatively, the third node can also use other direction calculation methods.

In some implementations, the steps to update the embedding position based on the gradient direction provided by the performance predictor include as follow.

First, determining the initial embedding position. Then, using backpropagation algorithm to compute the gradient direction provided by the performance predictor. Finally, obtaining the updated embedding position of the initial embedding position in a gradient ascent manner. The updated result is an optimized embedding position that performs better than the initial embedding position.

Specifically, the performance predictor can be trained through k sets of training data. Each set of training data contains a candidate neural architecture and its corresponding performance. The candidate neural architecture can be formed by multiple sampling embedding positions in the surrounding area of the initial embedding position.

It should be noted that the optimal neural architecture is only a current calculation result, not a global or final result. The third node 130 can also repeat the process of updating and optimizing the position multiple times to obtain better results. In other words, the aforementioned updating steps can be repeated multiple times.

In some embodiments, the search sub-node 131 can encode the initial neural architecture using a variational autoencoder to obtain the aforementioned initial embedding position. The initial neural architecture serves as the initialization result before the search, which can be allocated by the aforementioned first node or randomly generated by the third node.

For example, the search sub-node 131 can randomly generate the neural architecture based on a unique identifier as a seed and the search space given by the first node. The identifier can be assigned by the second node or automatically generated by the third node to distinguish different third nodes.

In preferred embodiment, in order to search in a search space that is more likely to have the optimal embedding position, the third node can directly jump to the top N optimal neural architectures as the search starting point, where N is a positive integer (such as 3, 4, or 5). In other words, the initial embedding position is the encoding result of the variational autoencoder of the top N optimal neural architectures.

In this article, the optimal neural architecture is the neural architecture sorted by performance based on the data information of all third nodes. In other words, different candidate neural architectures have corresponding sequence numbers based on their performance (neural architectures with better performance have earlier sequence numbers), thus forming a sequence of optimal neural architectures. Therefore, the top N optimal neural architectures can represent the neural architectures ranked Nth according to performance in the search results of all current third nodes.

In other embodiments, in order to ensure the reliability and credibility of data information between different third nodes, the third node 130 can also include a validation sub-node 133 to perform a validation process based on Merkle tree. Of course, the validation process can be performed by authorized nodes or competitively verified.

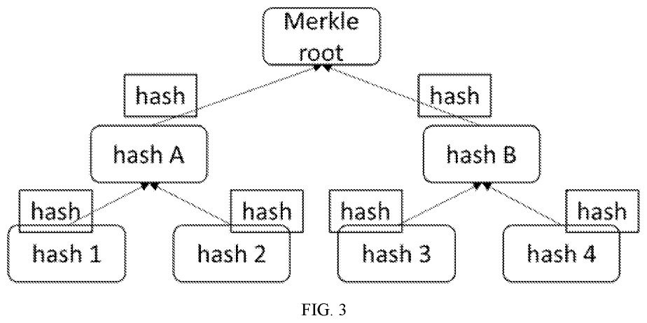

Specifically, FIG. 2 is a schematic diagram of the verification process according to the embodiment of the present application, and FIG. 3 is a schematic diagram of the Merkle tree according to the embodiment of the present application. As shown in FIG. 2 and FIG. 3, during the verification process, it is not necessary for the third node 130 to retrain the entire network. Instead, collective verification can be achieved by sampling a pair of adjacent hash values, namely hash n and hash n+1.

During the training of candidate neural architectures by the working nodes, the verification nodes calculate and publish the hash of the candidate neural architecture in the entire network, as well as compute the hash for fast verification. Then, each verification node randomly selects a pair of verification hash sequences. Then, the hash is broadcasted for another verification node to compute the Merkle root.

Based on the apparatus for collaborative neural architecture search, an embodiment of the present application also provides a method for collaborative neural architecture search. It can be executed by the nodes to perform neural architecture search in a collaborative manner.

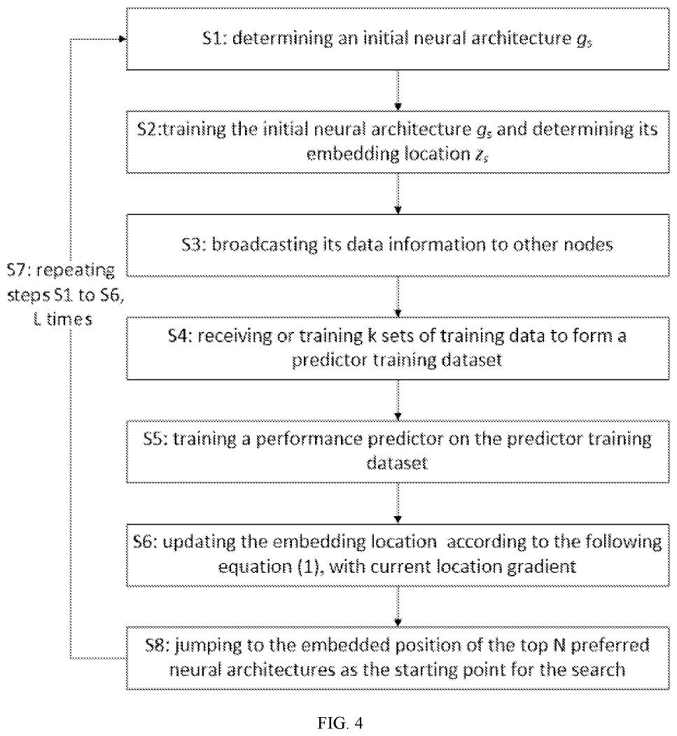

FIG. 4 is a flowchart of a method for collaborative neural architecture search according to embodiment of the present application. As shown in FIG. 4, the method may include the following steps:

S1: determining an initial neural architecture gₛ.

The initial neural architecture can be generated based on a random seed (e.g., an adjacency matrix), or it can be a specified neural architecture. The neural architecture can be considered a graph model consisting of nodes and edges.

S2: training the initial neural architecture gₛ and embedding it to a vector space through a variational autoencoder to determine its embedding location zₛₒ

The variational autoencoder is provided by the second node and can encode discrete neural architectures into continuous encodings in the vector space (neural architectures with similar structures and performance have embeddings that are close to each other).

S3: broadcasting its data information to other nodes.

The data information may include the training results and performance evaluation results of the neural architecture.

S4: receiving or training k sets of training data to form a predictor training dataset S and Z.

Each set of training data consists of a neural architecture and its corresponding performance evaluation result. Specifically, it can be represented by the following equation: S={(gₛ, pₛ), (g₁, p₁), (g₂,p₂) . . . (gₖ,pₖ)}; Z={(zₛ, pₛ), (z₁, p₁), (z₂,p₂) . . . (zₖ,pₖ)}, wherein p is the performance evaluation result of the neural architecture, and the subscript is the index of the neural architecture.

S5: training a performance predictor on the predictor training dataset.

Specifically, the weights of the performance predictor can be updated through gradient descent to obtain the required performance predictor.

S6: updating the embedding location zₛ' according to the following equation (1), with current location gradient.

$${z}_{s}^{′} = {z}_{S} + σ μ τ \frac{\partial P ( {z}_{s} , {w}_{s} )}{\partial {z}_{s}} \qquad ( 1 )$$

Wherein σ is the standard provided by the variational autoencoder, μ is the step size of gradient ascent, and τ is a constant. The updated embedding location zₛ' is a location with better performance and can be decoded by the variational autoencoder into a specific neural architecture.

S7: repeating steps S1 to S6 above L times. Lis a positive integer that can be set according to actual needs (e.g., based on a pre-set upper limit on computational resources or computation time).

In some embodiments, please refer to FIG. 4, after step S16, an optional step S18 may be included to facilitate the search within the search space of the neural architecture that is most likely to exhibit strong performance.

S8: jumping to the embedded position of the top N preferred neural architectures as the starting point for the search.

The top N preferred neural architectures can be determined based on the search results of this node or the search results of other nodes, indicating the neural architecture ranked N^{th} in performance evaluation results among the existing search results.

Finally, it should be noted that the above embodiments are only intended to illustrate the technical solution of the present invention, and not to limit it. Under the concept of the present invention, the technical features in the above embodiments or different embodiments can also be combined, and the steps can be implemented in any order. Many other changes exist in the different aspects of the present invention as described above, which are not provided in detail for the sake of simplicity, Although the embodiments above have been described in detail with reference to the present invention, those skilled in the art should understand that they can still modify the technical solutions described in the above embodiments or replace some technical features with equivalent ones. These modifications or replacements do not depart from the scope of the technical solutions of the various embodiments of the present invention

What is claimed is:

1. An apparatus for collaborative neural architecture search,
wherein the system consists of a collective set of independent computation nodes, wherein each of the nodes share a ledger that records the fitness of a set of mathematical models with respect to the dataset;
each of the nodes run the processes comprises: an Initialization process, search space division process, parameter tunning process, validation process and search process wherein the initialization process is is a process to maintain the supply of data and in the amid of the initialization process, each node broadcast the specification of the problem;
wherein the specification of the problem comprises:
the types of neural architectures allow to be generated in the search process,
the evaluation method, the termination criteria of the parameter tunning,
the target dataset,
the training dataset, and
the test dataset;
wherein the search space division process is a process that is responsible for broadcast a fully trained VAE (variational autoencoder) or a mathematical model that takes in a random vector and outputs a graph,
wherein the variational autoencoder is used to embedding a neural architecture to a vector space so that neural architectures with similar structures have adjacent embedding positions;
at least two mutually collaborative third nodes;
wherein the third node is used to determine a performance of multiple candidate neural architectures, train a performance predictor, and update the embedding position based on the gradient direction provided by the performance trainer;
wherein data information is shared among different third nodes, and the data information comprises the performance of candidate neural architectures.

2. The apparatus according to claim 1, wherein the initialization process is namely a first node and the search space division process is namely a second node;
wherein the first node is configured for providing a preset search space and dataset, and the second node is configured for generating a variational autoencoder and dividing the search space;
wherein the variational autoencoder is trained on an encoder training dataset and broadcasted to the third nodes;
wherein the encoder training dataset consists of several randomly generated neural architectures that meet the search space; and
the distribution of the neural architectures in the vector space is selected from a Gaussian distribution with a standard deviation of 1 or the distribution specified by the first node.

3. The apparatus according to claim 1, wherein the step of updating the embedding position based on the gradient direction provided by the performance trainer comprises:
determining the initial embedding position;
calculating the gradient direction given by the performance predictor through backpropagation algorithm, and
obtaining the updated result of the initial embedding position through gradient ascent;
wherein the updated result is an optimized embedding position that performs better than the initial embedding position.

4. The apparatus according to claim 3, wherein the initial embedding position is the embedding position of the initial neural architecture in the vector space, which is selected from the neural architecture assigned by the first node or a randomly generated neural architecture;
wherein the randomly generated neural architecture is generated randomly based on the identifier as the random seed and the setting of the search space; and
the identifier is assigned by the second node or generated automatically by the third node.

5. The apparatus according to claim 3, wherein the initial embedding position is the embedding position according to the top N preferred neural architectures in the vector space;
wherein N is a positive integer, and the preferred neural architectures are sorted according to the performance evaluation results, and neural architectures with better performance have lower numbers.

6. The apparatus according to claim 3, wherein the step of training to obtain a performance predictor comprises:
obtaining k sets of training data to form a predictor training dataset;
training the performance predictor based on the predictor training dataset;
wherein each set of training data comprises: candidate neural architecture and its corresponding performance, and the candidate neural architecture is sampled from a peripheral area of the initial embedding position.

7. The apparatus according to claim 1, wherein the third node comprises:
a search sub-node for determining candidate neural architectures for work sub-node;
a work sub-node for determining the performance of the candidate neural architectures, training a performance predictor, and updating the embedding position; and
a validation sub-node for performing a verification process based on a Merkel tree in a non-trusted environment to verify the data information broadcasted by other third nodes.

8. The apparatus according to claim 7, wherein the work sub-node is further configured to test the performance of the candidate neural architectures through the dataset or obtain the performance of the candidate neural architectures by collecting data information from other third nodes.

9. A method for collaborative neural architecture search, comprising:
S1: determining and training an initial neural architecture;
S2: embedding the initial neural architecture to an initial embedding position in a vector space using a variational autoencoder;
S3: broadcasting the data information of the initial neural architecture;
S4: obtaining k sets of training data to form a predictor training dataset, wherein k is a positive integer,
S5: training a performance predictor using the predictor training dataset;
S6: updating the embedding positions in the direction of the gradient provided by the performance predictor using gradient ascent, such that the updated embedding positions perform better than the initial embedding position;
S7: repeating steps S1 to S6 L times, wherein L is a positive integer.

10. The method for collaborative neural architecture search according to claim 9, wherein the method further comprises:
S8: jumping to the embedding position of the top N preferred neural architectures in the vector space;
wherein N is a positive integer, and the preferred neural architectures are sorted by performance, and those with better performance have a lower index.
